(19) United States
(12) Patent Application Publication
(10) Pub. No.: US 2026/0220183 A1
(43) Pub. Date: Jul. 30, 2026

(54) DYNAMIC TOPIC BASED CATEGORIZATION AND RETRIEVAL AUGMENTED GENERATION

(71) Applicant: HEWLETT PACKARD ENTERPRISE DEVELOPMENT LP, Spring, TX (US)

(72) Inventors: Sidhant Arora, Spring, TX (US); Mark Perreira, Sunnyvale, CA (US); Ian Matthews, Galway (IE); Pon Arasu Neranj Subramanian, Spring, TX (US); Umang Kedia, Spring, TX (US)

(21) Appl. No.: 19/037,655

(22) Filed: Jan. 27, 2025

(51) Int. Cl. G06F 16/355; G06F 16/2455

(52) U.S. Cl. CPC G06F 16/355; G06F 16/2455

(57) ABSTRACT

Systems and methods are provided for a retrieval-augmented generation (RAG) system that categorizes resources into dominant topics and groups the resources into subsets corresponding to the dominant topics, which can be used to retrieve those resources that are probabilistically relevant to a topic of a query. Examples generate topics using a topic model that analyzes content of external resources and creates data structures based on the topics that groups the external resources according to the topics. Examples map a query to a data structure of the data structures based on a correspondence between an queried topic of the query and a topic of the data structure, retrieve the external resources corresponding to the mapped data structure using an information retrieval algorithm, and feed the external resources and the query into a generative artificial intelligence model that generates an output responsive to the query based on the external resources.

### BACKGROUND

Retrieval augmented generation (RAG) is a technique that can be used to optimize outputs of generative artificial intelligence (AI) models, such as large language models (LLMs), through information retrieval capabilities. Generative AI models are generally trained on vast volumes of data and use billions of parameters to generate outputs for tasks, such as answering queries, translating languages, and completing sentences. RAG techniques augment tasks with a generative AI model by referencing a knowledge base external to the model's training data, before generating a response. This can allow the generative AI model to use domain-specific knowledge, an organizations internal knowledge base, and/or updated information in constructing an output, without retraining the generative AI model.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 is a block diagram of an example environment for retrieval augmented generation (RAG), in accordance with implementations of the present disclosure.

FIG. 2 is a flowchart illustrating an example process for creating a plurality of collections and a plurality of dominant topics, in accordance with examples of the present disclosure.

FIG. 3 is a flowchart illustrating an example process for generating a plurality of dominant topics, in accordance with an example of the present disclosure.

FIG. 4 is a flowchart illustrating an example process for defining a plurality of collections, in accordance with an example of the present disclosure.

FIG. 5 is a flowchart illustrating an example process for performing retrieval and augmentation of a query, in accordance with examples of the present disclosure.

FIG. 6 is a block diagram of an example environment for dynamic RAG, in accordance with an example implementation of the present disclosure.

FIG. 7 is a flowchart illustrating an example process of a dynamic retrieval and augmentation, in accordance with an example of the present disclosure.

FIG. 8 is an example computing component that may be used to implement various features of retrieval augmented generation in accordance with the implementations disclosed herein.

FIG. 9 illustrates another example computing component that may be used to implement retrieval augmented generation in accordance in accordance with the implementations disclosed herein.

FIG. 10 is a computing component that may be used to implement examples of the disclosed technology.

The figures are not exhaustive and do not limit the present disclosure to the precise form disclosed.

### DETAILED DESCRIPTION

Examples of the technology disclosed herein improve upon existing retrieval-augmented generation (RAG) systems by categorizing a corpus of resources into a plurality of dominant topics and grouping the external resources into subsets corresponding to the dominant topics. By leveraging the categorization according to the present disclosure, when a query is provided to a generative AI model, such as an LLM, the examples disclosed herein can analyze the query to infer a queried topic relevant to the query and retrieve those resources that are probabilistically relevant to the topic. For example, the examples disclosed herein can map the queried topic to a dominant topic. The resources corresponding to the dominant topic can be accessed and analyzed to identify resources that are probabilistically relevant to the queried topic from those resources corresponding to mapped dominant topic. In various examples, only those resources corresponding to the dominant topic are accessed for locating probabilistically relevant resources.

LLMs can be large and costly to train. RAG techniques can be used to retrieve resources from a knowledge base that is external to (e.g., outside or not included as part of) data on which the LLM was trained for providing context to a query submitted to an LLM. The query can be augmented by adding the resources to the query prior to submitting the query to the LLM. The LLM can then output a response by applying its learned knowledge to the query and resources. As described above, the resources added by the RAG techniques are external resources that do not train the LLM, but are instead analyzed and processed by the trained LLM to output a response that is relevant to the context of the query.

The terms “external” or “outside” in the context of resources and knowledge basis are used herein to refer to data or resources (e.g., textual documents, webpages, images, video, audio, and the like) that are not part of data used to train the LLM.

Conventionally, RAG access a knowledge base that collects all external resources into a single logical grouping. These logical groupings, in some applications, can be commonly referred to as a “collection” in certain vector databases and libraries, such as, but not limited to, LangChain and the like). In other vector databases and libraries, these logical groupings may be referred to as indexes (e.g., such as in Pinecone and FAISS) or tables of vectors (e.g., such as in PostgreSQL). This logical grouping may be include domain-specific resources and/or an organization's internal knowledge base. In this case, when RAG retrieves external resources, it does so from a large corpus of external resources contained within the single logical grouping. The term “collection” will be used herein to refer to the single logical groupings. As such a collection, as used herein, may be refer to collections, indexes, tables, or other logical groupings depending on the vector database utilized according to the present disclosure.

A large corpus of external resources can be highly diverse, which may dilute the relevance of each external resource and make it increasingly difficult to retrieve the most relevant external resources. For example, RAG can use similarity between a query and resources to locate resources that are relevant to the query. The most similar resources may be the most probabilistically relevant to the query. Thus, as the diversity of resources within a collection increases, similarities may be spread across numerous documents, diluting the probabilities and making it increasingly difficult to locate the most relevant resources.

Additionally, as the knowledge base expands to include more and more resources, noise and redundancy can be introduced into the collection. For example, irrelevant or redundant information contained in multiple resources may interfere with the retrieval process, for example, by causing the retrieval process to select resources containing irrelevant and/or redundant information. This can cause the LLM to select less appropriate passages for generating responses, resulting in lower-quality outputs compared to a more focused knowledge base.

Furthermore, resources may conflict with one another, which can lead to inconsistencies. For example, the information contained in different resources may conflict or contradict each other, such as where one resource contains past information while another resource contains new, updated information that contradicts with the past information. The RAG, in this case, may retrieve both resources (or worse, only that resource containing the past information), thereby leading to inconsistencies in the retrieved knowledge. In such cases, the model may struggle to reconcile conflicting information, which can affect the coherence and accuracy of the generated responses.

Further still, as the size of the knowledge base increases, the computational demands of processing and retrieving information also rise. For example, if the RAG model is not adequately scaled to handle a large knowledge base, performance and consumption of computation resources may degrade due to resource constraints.

Examples of the technology disclosed herein provide a technical solution to the above technical problems. For example, the technology disclosed herein provides a RAG system configured to generate a plurality of dominant topics using a topic model that analyzes content of a corpus of external resources. The corpus of external resources may correspond to one or more knowledge bases, such as an organizations internal documents and files and/or multiple domain-specific knowledge bases. Examples herein may utilize latent Dirichlet allocation (LDA) to extract keywords from the external resources and generate a set of topics that dominate the external resources (e.g., dominant topics). Examples create data structures for the dominant topics. The external resources can be classified into the dominant topics and the data structures updated to map collections of the external resources to the dominant topics. In examples, each data structure corresponds to a dominant topic and references a collection of the external resources assigned to the dominant topic. The data structure may be stored in a first data store, for example, a relational database.

Examples herein may create a plurality of collections corresponding to the plurality of dominant topics. For example, the external resources can be converted into numerical representations, such as vectorized embeddings, for storage in second data store, for example, a vector database. The numerical representations can be allocated to the plurality of collections. In examples, each collection may correspond to a particular dominant topic. In this case, the numerical representations of the external resources mapped to a particular dominant topic can be allocated to a collection corresponding to the particular dominant topic. As a result, the data structure function to map each dominant topic to a corresponding collection of numerical representations of the external resources mapped to each respective dominant topic. The resources may include, but are not limited to, textual documents (e.g. PDFs, documents generated by word processor programs, etc.), charts, graphs, webpages, images, videos, audio, multimedia content and the like.

Subsequently, a query can be submitted to the RAG system, for example, by an end-user device, that asks a question to be feed into an LLM. The examples disclosed herein may be configured to analyze the query and identify keywords or phrases from the query. Examples herein may employ natural language processing (NPL) or the like to analyze the query. The identified keywords or phrases can be extracted and used to infer a topic of the query (referred to herein as a “queried topic”). The query can then be mapped to one of the data structures by comparing the queried topic to each of the dominant topics of the data structures. The dominant topic having the highest similarity to the queried topic can be selected and the corresponding data structure mapped to the query.

The disclosed technology can then execute a retrieval process to access those external resources referenced in the mapped data structure. For example, the mapped data structure may reference a collection of the plurality of collections corresponding to the selected dominant topic. Examples herein access this collection via the reference contained in the mapped data structure and perform a search of the external references in this collection that are probabilistically relevant to the query. The most relevant external resources can be retrieved and added to the query as a context (referred to herein as an augmented query). The augmented query can be fed to the LLM via prompt engineering, which applies its learned knowledge to generate an output that is responsive to the query and according to the context of the retrieved external resources.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

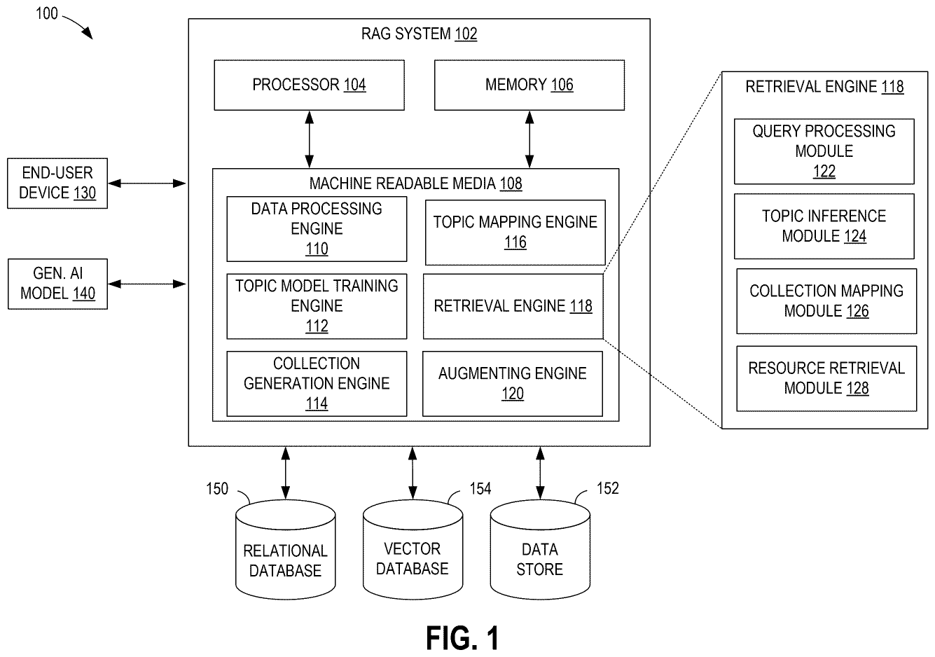

FIG. 1 is a block diagram of an example environment 100 for RAG, in accordance with implementations of the present disclosure. In the example of FIG. 1, environment 100 comprises a RAG system 102 that is communicable coupled (e.g., via wired or wireless communication connection) to an end-user device 130, a generative AI model 140 and a plurality of data stores 150-154. RAG system 102 may be a server computer that communicates via network communications to other devices accessible on the network, including end-user device 130, generative AI model 140, and data stores 150-154. In some examples, the data stores 150-154 may be cloud-based database, included as part of RAG system 102, or combinations thereof. In examples, the data stores 152 may store a corpus of external documents that may be accessed by the RAG system 102.

Generative AI model 140 may be hosted by a third party system. In examples, generative AI model 140 may be trained on vast volumes of data from a general knowledge base and configured to generate outputs for tasks, such as answering queries, translating languages, and completing sentences. In examples, the generative AI model 140 may be one or more LLM tools, such as but not limited to, the GPT series of models, Gemini, LLaMA models, and the like.

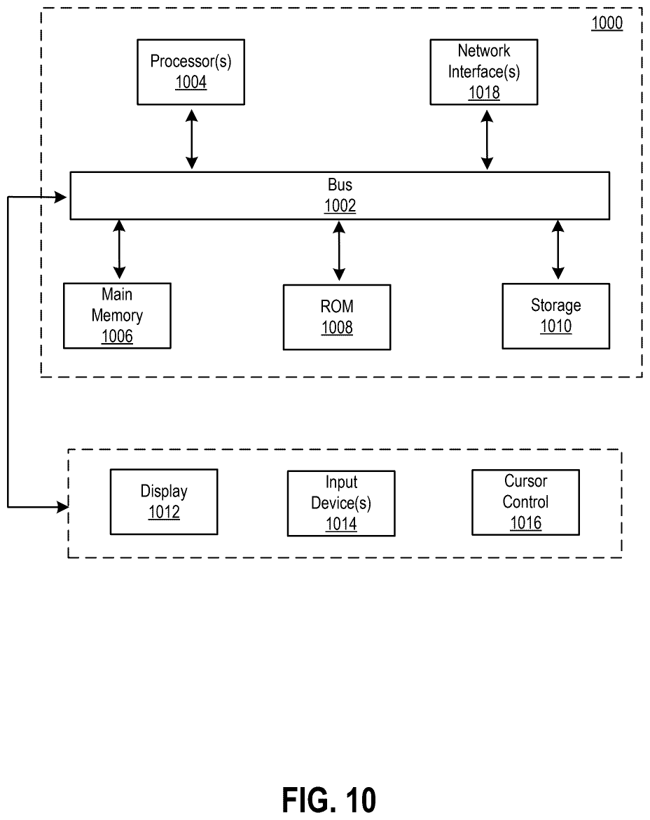

End-user device 130 may be any computing device or system, such as, but not limited to, a smartphone, a laptop computer, a personal computer, a tablet, a wearable smart device, etc. The end-user device 130 may include an input device (as described in connection with FIG. 10) that may be employed for inputting a query into the end-user device 140. The input device may include, but is not limited to, alphanumeric and other keys, a mouse, a trackball, or cursor direction keys for communicating direction information and command selections, touches and on a touch screen, voice command inputs, and the like. In examples, an end-user may input a query into the end-user device 130 via the input device with the end goal receive an output from the generative AI model 140 that is relevant to the query.

The RAG system 102 may be configured to optimize outputs of the generative AI models 140 by retrieving external resources for providing context to the query. The query can be augmented by adding the retrieved external resources to the query prior as context and the augmented query can be submitted to the generative AI model 140. The submitted to the generative AI model 140 can then output a response by applying its learned knowledge to the augmented query and forwarded to the end-user device 130. The RAG system 102, in examples according to the present disclosure, can be configured to categorizing a corpus of external resources into a plurality of dominant topics and retrieve external resources by correlating a queried topic, inferred from the query, with a dominant topic of the plurality of dominant topics. The RAG system 102 can then augment the query with the retrieved resources. By leveraging the categorization according to dominant topics, the generative AI model 140 is able to generate an output that is responsive to the query and based on the external resources.

In the example of FIG. 1, the RAG system 102 comprises processor 104, memory 106, and machine readable media 108.

Processor 104 may comprise a general-purpose or special-purpose processing engine such as, for example, a microprocessor, controller, or other control logic. Processor 104 may be connected to a bus, although any communication medium can be used to facilitate interaction with other components of RAG system 102 or to communicate externally.

Memory 106 may comprise random-access memory (RAM) or other dynamic memory for storing information and instructions to be executed by processor 104. Memory 106 might also be used for storing temporary variables or other intermediate information during execution of instructions to be executed by processor 104. Memory 106 may also comprise a read only memory (“ROM”) or other static storage device coupled to a bus for storing static information and instructions for processor 104.

Machine readable media 108 may comprise one or more interfaces, circuits, and modules for implementing the functionality discussed herein. Machine readable media 108 may carry one or more sequences of one or more instructions that can be executed by processor 104. Such instructions embodied on machine readable media 108 may enable RAG system 102 to perform features or functions of the disclosed technology as discussed herein. For example, the interfaces, circuits, and modules of machine readable media 108 may comprise, for example, data processing engine 110, topic model training engine 112, topic mapping engine 116, collection generation engine 114, retrieval engine 118, and augmentation engine 120.

Data processing engine 110 may be configured to process external resources to extract keywords or phrases. In examples, the RAG system 102 may access a corpus of external documents stored in one or more data stores 152. The corpus of external documents may correspond to a diverse knowledge base, such as an organization internal documents and files and/or various domain-specific knowledge bases. For example, the corpus of external resources may correspond to number domain-specific knowledge bases within organizations internal documents. The external documents may contain information describing any number of domains. The external documents may comprise textual documents (e.g. PDFs, documents generated by word processor programs, etc.), webpages, charts, graphs, images, videos, audio, multimedia content and the like. In any event, data processing engine 110 may function to access each external resource and process the external resource to obtain keywords and/or phrases. In the case of textual documents, webpages, and the like, the data processing engine 110 may execute NLP to extract key features, such as keywords and/or key phrases. In the case of videos, images, multimedia content, and the like, the data processing engine 110 may execute computer vision algorithms (e.g., CNN-based feature extract techniques and the like, as known in the art) to identify features, which can then be processed to obtain key features. In the case of chart and graphs, the data processing engine 110 may execute chart parsing algorithms, as known in the art, to extract key features of the chart and/or graphs.

The topic model training engine 112 may be configured to generate a plurality of dominant topics using a topic model that analyzes the key features extracted by the data processing engine 110. In some examples, topic model training engine 112 trains a topic model on the extracted key features to generate a set of topics that dominate the key features (e.g., dominant topics). For example, the topic model training engine 112 may be configured to, for each external resource, attribute each key feature's presence within the external resource to a topic of the external resource. The topic model discovers sets of key features, corresponding to topics, based upon co-occurrence of each key feature within the external documents. In examples, a number N of topics may be set in advance, for example, via the end-user device 130, and the dominant topics may be the top N topics discovered by the topic model in the corpus of external resources. In examples, the topic model training engine 112 uses LDA to discover the set of topics that dominate the key features extracted from the external resources (e.g., dominant topics). However, any topic model may be utilized that can discover topics from a corpus of external resources.

The topic model training engine 112 may also be configured to classify the external resources into one or more of the dominate topics. For example, a number n top of key features (e.g., top n most relevant key features) may be set in advance, for example, via the end-user device 130, and an external resource can be classified into a dominant topic according to a similarity of key features extracted from the external resource and the n top key features of a dominant topic. The similarity between the external resource and a given dominant topic can be computed and the external resource can be probabilistically classified into each of the dominant topics. For example, the key features extracted from an external document can be compared to the top n key features defining the dominant topics and the similarity therebetween can be used to classify the external resource to a dominant topic. Similarity may be computed using known similarity algorithms, for example but not limited to, cosine similarity, Euclidean distance, Manhattan distance, Jaccard similarity, dot product, soft cosine, angular distance, and the like.

The collection generation engine 114 may be configured to create a plurality of collections based on classifying external resources into the dominant topics. For example, the collection generation engine 114 may be configured to group external resources according to the dominate topic classifications. That is, external resources classified into a given dominant topic can be grouped into one collection and external resources classified into another dominate topic can be grouped into another collection. In some examples, an external resource may be classified into one or more dominate topics. Thus, an external resource may be grouped into a one or more collections.

The collection generation engine 114 may be configured to generate numerical representations of each collection (referred to herein as a topical numerical representation). For example, the collection generation engine 114 can be configured to convert the external resources grouped into a collection into a numerical representation, such as vectorized embedding, for storage in data store 154. In an example, data store 154 may be a vector database. In examples, a single topical numerical representation may be generated for each collection, which may be a numerical representation of the dominate topic corresponding to the collection.

In some examples, the collection generation engine 114 may be configured to generate numerical representations of each external resource (referred to herein as a resource numerical representation). For example, the collection generation engine 114 can be configured to convert a given external resource into a number of chunk numerical representations, such as chunk vectorized embeddings, for storage in data store 154. Thus, in examples, a single external resource can be stored in the data store 154 as chunk embeddings. For example, a single external resource can be represented by 10 chunk embeddings.

The topic mapping engine 116 may be configured to map the plurality of collections created by the collection generation engine 114 to dominant topics generated by the topic model training engine 112. In examples, the topic mapping engine 116 may be configured to map a collection to a dominate topics, thereby mapping the corresponding external resources to a dominate topic. For example, the topic mapping engine 116 may be configured to create a data structure for each dominate topic that associates the dominate topic to a corresponding collection. In this case, the data structure may comprise a topic name or identifier of the dominant topic, a collection name or identifier (sometimes referred to herein as a reference) of the associated collection, and a topical numerical representation of the collection generated by the collection generation engine 114. The data structure may also include a creation time of the collection, such as a timestamp of when the collection was created; an update time of when the collection was last updated, such as a timestamp of the last update; and a listing of the top n key features (e.g., top n most relevant key features) that represent the topic. In some examples, the data structure may be provided as a data table having columns populated with the data outlined above.

In examples, individual external resources can be indexed and stored within the collections in the data store 154 as resource numerical representations. Data store 154 may be configured to manage the relationship between collections and external resources. The collection name included in the data structure can act as a pointer for a corresponding collection located in the data store 154. A such, a collection name can be used by the RAG system 102 to locate the collection within the data store 154 and access the external resources contained therein (e.g., corresponding to a dominant topic mapped to the collection). In this way, external resources can be mapped to a given dominant topic (or a plurality of dominate topics in some examples).

The topic mapping engine 116 may store the data structure in data store 150. In examples, the data store 150 may be a relational data store. For example, data store 150 may be a structures query language (SQL) database or the like. Accordingly, in some examples, the data structures may be relational data structures, such as SQL tables or the like.

The retrieval engine 118 may be configured to execute a retrieval process. For example, upon receiving a query from the end-user device 130, the retrieval engine may locate and access a collection of the plurality of collections stored in the data store 154. For example, the retrieval engine 118 may be configured to map the query to a data structure and locate the collection referenced in the mapped data structure. To perform this mapping, the retrieval engine 118 may be configured to infer a queried topic from the query, which can be mapped to a data structure stored in data store 150 based on similarity between the queried topic and the dominant topics. The data-structure corresponding to the most similar dominant topic can be mapped to the query. The retrieval engine 118 may then be configured to access the collection referenced in the mapped data structure and execute an information retrieval algorithm (e.g., a RAG process) that searches the external resources contained in this collection to retrieve external resources that are probabilistically relevant to the query. Thus, the search can be confined to a collection that is relevant to the queried topic and only those external resources that are particularly relevant may be retrieved.

In the example of FIG. 1, the retrieval engine 118 may comprise a query processing module 122, a topic inference module 124, a collection mapping module 126, and a resource retrieval module 128.

In examples, the query processing module 122 may be configured to process the query to extract key features (e.g., key words and phrases in the case of a textual query), similar to the data processing engine 110. In some examples, the query processing engine 122 may submit the query to the data processing engine 110 for processing and receive extracted key features from the data processing engine 110.

The topic inference engine 124 may be configured to obtain key features of the query and infer a queried topic from the obtained key features. The topic inference engine 124 may be configured to discover a topic, for example, in a manner similar to the topic model training engine 114, except that the inference is confined to a single set of key features. In examples, the topic inference engine 124 may be configured to generate a numerical representation of the query (referred to herein as a query numerical representation). For example, the topic inference engine 124 can be configured to convert the key features of the query into a vectorized embedding. The vectorized embedding (e.g., query numerical representation) may be used as the queried topic of the query.

The collection mapping module 126 may be to map the query to a data structure based on a comparison of the queried topic and the dominant topics. For example, the collection mapping module 126 may determine similarity between the queried topic and each of the dominant topics. The collection mapping module 126 may identify the dominant topic having the highest similarity and map the query to the data structure corresponding to the identified dominant topic. In this way, the collection referenced in the mapped data structure can be associated with the query.

In an example, the collection mapping module 126 may compute a similarity of the query numerical representation to each topical numerical representation of the data structures. The collection mapping module 126 may identify the topical numerical representation having the highest similarity and associate the query to the data structure corresponding to the identified topical numerical representation. The collection mapping module 126 may then retrieve the data structure containing the identified topical numerical representation. Similarity may be computed using known similarity algorithms, for example but not limited to, cosine similarity, Euclidean distance, Manhattan distance, Jaccard similarity, dot product, soft cosine, angular distance, and the like.

In some examples, the collection mapping module 126 may use a BERT model to match the queried topic to the dominate topics. With BERT, both the dominate topics generated by the topic model training engine 112 and the queried topic of the query can be represented as embeddings. Similarity scores can be calculated between these embeddings to find the best match.

The resource retrieval module 128 may be configured to access the referenced collection and execute the information retrieval algorithm to retrieve external resources relevant to the query. For example, resource retrieval module 128 may be configured use the identified dominant topic (e.g., identified topical numerical representation) to retrieve a topic name specifying a corresponding data structure. The resource retrieval module 128 may be configured to access a collection referenced in the data structure via a collection name and perform a search of the external references in this collection. For example, the collection name may be used as a pointer to locate the collection in the data store 154. The resource retrieval module 128 may compare the query to the external references to locate those references that probabilistically relevant (e.g., most similar) to the query. The most relevant external resources can be retrieved. In examples, the relevancy of the external documents may be determined by computing a similarity between the query and each external resource in the collection. In one example, the k number of external resources having the highest similarity may be determined as the most relevant. In another example, a threshold similarity may be set in advance and any external reference having a similarity above the threshold may be retrieved.

In an example, resource retrieval module 128 may be configured to execute an information retrieval algorithm that searches the external resources using numerical representations stored in the data store 154. For example, resource retrieval module 128 may be configured to convert the query into a numerical representation (e.g., a vectorized embedding). The resource retrieval module 128 may then access the referenced collection in the data store 154 to locate numerical representations contained in the referenced collection that are probabilistically similar to the numerical representation of the query. In examples, the numerical representations of external resources that are the most similar to the numerical representation of the query may be retrieved. In examples, resource retrieval module 128 may execute cosine similarity to compute a similarity score between the numerical representation of the query and numerical representations of the external resources. However, other methods for computing similarity may be used, such as, but not limited to, Euclidean distance, Manhattan distance, Jaccard similarity, dot product, soft cosine, angular distance, and the like. The numerical representations of the external resources can be sorted according to similarity score (e.g., highest similarity to lowest) and the most similar may be identified as probabilistically relevant to the query.

The augmenting engine 120 may be configured to generate an augmented query and submitting the augmented query to the generative AI model 140. For example, the augmenting engine 120 may be configured to add the external resource retrieved by the retrieval engine 118 to the query received from the end-user device 130 as a context, which collectively define the augmented query. In examples where the external resource are retrieved as numerical representations, augmenting engine 120 (or resource retrieval module 128) may convert the numerical representations back into external resources that can be processed by the generative AI model 140. The augmented query can be feed to the generative AI model 140 via prompt engineering. As explained above, the generative AI model 140 applies its learned knowledge to the augmented query and generates an output that is responsive to the query and according to the context defined by dominant topic mapped to the query.

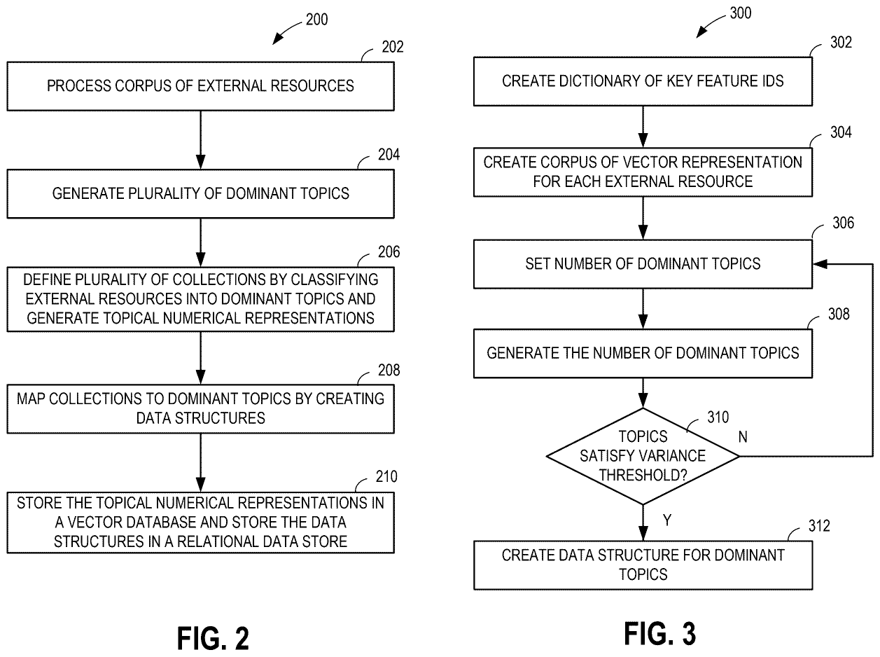

FIG. 2 is a flowchart illustrating an example process 200 for creating a plurality of collections and a plurality of dominant topics, in accordance with examples of the present disclosure. In examples, process 200 may be implemented as machine-readable instructions that may cause a processor to perform the operations described herein. In some examples, RAG system 102 may be implemented to execute one or more operations disclosed herein.

At operation 202, external resources are processed to extract key features. For example, a corpus of external documents may be stored in one or more data stores (e.g., data store 152) that correspond to a diverse knowledge base. In examples, each external resource may be processed to obtain key features. In the case of textual documents, webpages, and the like, operation 202 may include executing NLP to extract key features as keywords and/or key phrases. In the case of videos, images, multimedia content, and the like, the operation 202 may include executing computer vision algorithms to identify features, which can then be processed to obtain key features. In the case of chart and graphs, operation 202 may include executing chart parsing algorithms to extract key features of the chart and/or graphs.

In an illustrative example, operation 202 may execute a plurality of operations to identify and extract key features. For example, with reference to a textual document, operation 202 may extract all text through optical character recognition techniques and normalize the text, for example, by converting the text to lower case. In some examples, URLs may located and removed, if present. Punctuation may be removed as well. The remaining text may be tokenized into words, for example, by splitting the text into individual words. Stop words (e.g., words commonly used in language) may be removed according since the commonality of these words mean that these words are not informative on key features. Operation 202 may perform stemming on each remaining word to convert the word to its most basic form (e.g., converting “changing”, “changed”, and/or “change” into “chang”). The stemmed words may then be joined into a string of words that represent the external resource being processed.

At operation 204, a plurality of dominant topics may be generated from the processed external resources. For example, operation 204 may use a topic model to analyze the key features extracted at operation 202 and generate a plurality of topics for the external resources. In examples, operation 204 may use LDA to discover the set of topics that dominate the key features. While examples herein are described as using LDA, any topic model may be utilized that can discover topics from a corpus of external resources. The most dominant N topics of the discovered topics may be identified as the plurality of dominant topics. The number N may be specified in advance, for example, via an end-user device (e.g., end-user device 130). An example of operation 204 is provided below in connection with FIG. 3.

At operation 206, a plurality of collections can be defined by classifying the external resources into one or more of the dominate topics. For example, a number n top of key features (e.g., top n most relevant features) may be set and a given external resource can be classified into a dominant topic according to a similarity of key features extracted from the external resource and the n top key features of a dominant topic. The similarity between the external resource and a given dominant topic can be computed and the external resource can be probabilistically classified into one or more of the dominant topics. For example, the key features extracted from an external document can be compared to the top n key features defining the dominant topics and the similarity therebetween can be used to classify the external resource to a dominant topic.

Operation 206 may include grouping external resources according to the dominate topic classifications. That is, external resources classified into a given dominant topic can be grouped into one collection and external resources classified into another dominate topic can be grouped into another collection. In some examples, an external resource may be classified into one or more dominate topics. Thus, an external resource may be grouped into a one or more collections.

Operation 206 may include generating topical numerical representations of the collection. For example, the external resources grouped into a collection can be converted into a numerical representation, such as a vectorized embedding. In examples, a single topical numerical representation may be generated for each collection, which may be a numerical representation of the dominate topic that dominates the collection. To generate the topical numerical representation, the external resources of a collection may be processed, for example, according to operation 202 to obtain a string of stemmed key features. Each key feature may be converted to a number according to language modeling and/or feature learning techniques.

In some examples, the operation 206 may include generating numerical representations of each external resource (referred to herein as a resource numerical representation). For example, external resource can be converted into a number of chunk numerical representations, such as chunk vectorized embeddings. Each external resource may be divided into a number of chunks. The number of chunks may be set in advance. Each chunk may be processed, for example, according to operation 202 to obtain a string of stemmed key features. Then each key feature may be converted to a number according to language modeling and/or feature learning techniques. Thus, in examples, a single external resource can be represented as chunk embeddings. For example, a single external resource can be represented by 10 chunk embeddings. In some examples, generating numerical representations of each external resource need not be performed at operation 206 and can performed at any point prior to operation 206. At operation 208, the plurality of collections can be mapped to the plurality of dominant topics. For example, operation 208 may map a collection to a dominate topics, thereby mapping the corresponding external resources to a dominate topic. A data structure may be created for each dominate topic that associates the dominate topic to a corresponding collection. The data structure, for example, may comprise a topic name of the dominant topic, a collection name of the associated collection, and a topical numerical representation of the collection generated at operation 206. The data structure may also include a creation time of the collection, such as a timestamp of when the collection was created; an update time of when the collection was last updated, such as a timestamp of the last update; and a listing of the top n key features (e.g., top n most relevant key features) that represent the topic. In some examples, the data structure may be provided as a data table having columns populated with the data outlined above.

Operation 208 may also include creating data structures for the dominate topics that associates dominate topics to corresponding collections. For example, the data structure may comprise a topic name of the dominant topic, a collection name of the associated collection, and a topical numerical representation of the collection generated at operation 206. The data structure may also include a creation time of the collection, such as a timestamp of when the collection was created; an update time of when the collection was last updated, such as a timestamp of the last update; and a listing of the top n key features (e.g., top n most relevant key features) that represent the topic. In some examples, the data structure may be provided as a data table, for example, an SQL table or the like.

At operation 210, the topical numerical representations can be stored to a vector database. For example, the topical numerical representations generated at operation 206 can be stored in to data store 154. Likewise, the resource numerical representations generated at operation 206 (or elsewhere) may be stored to the vector database, such as data store 154.

Operation 210 may also include storing the data structures in a relational data store, such as data store 150. In examples, the relational data store may be a structures query language (SQL) database or the like.

FIG. 3 is a flowchart illustrating an example process 300 for generating a plurality of dominant topics, in accordance with an example of the present disclosure. Process 300 may be an example implementation of operation 204 above.

One or more operations of process 300 may be executed to generate a plurality of dominant topics from external resources, such as those processed in operation 202. At operation 302, a dictionary of key feature identifiers (key feature IDs) can be created from the processed key features. For example, the various stemmed key features can be tokenized and added to the dictionary of key features as an example of a key feature ID. Operation 304 may be executed for each external resource to create a corpus of numerical representations for the respective external resource. That is, each key feature of a given external resource can be converted to a number and collected to form a corpus of numerical representations for that external resource. A number N of topics may be set in advance at operation 306, for example, via an end-user device, and a topic model may be execute to discover a set of topics at operation 308. The set of topics may represent all topics discovered from the corpus of numerical representations, which may be filtered to the top N most dominant topics at operation 308, which outputs the N most dominant topics as the plurality of dominant topics.

At decision 310, a determination can be made as to whether or not the plurality of dominant topics satisfy a variance threshold. The variance threshold may be set in advance, for example, at an end-user device to indicate a desired amount of variance within a given dominant topic and amongst the dominant topics. A covariance within a given dominant topics and a covariance amongst the dominant topics can be computed and compared to the variance threshold. If the threshold is not satisfied, process 300 returns to operation 306 to update the number N in order to satisfy the threshold. For example, the variance threshold may define an upper and lower variance bound that of the covariance. If the covariance is above the upper bound, then the number of dominant topics may need to be reduced to reduce the covariance. Whereas, if the covariance is below the lower bound then the number of dominant topics may need to be increased to increase the covariance.

If the threshold is satisfied, process 300 proceeds to operation 312. At operation 312, a data structure can be created and stored in a data store (e.g., data store 150), for example, as described above in connection with operation 204 of FIG. 2. For example, a seed data structure can be created that contains a topic name, which can be populated with additional information according to process 200 described above.

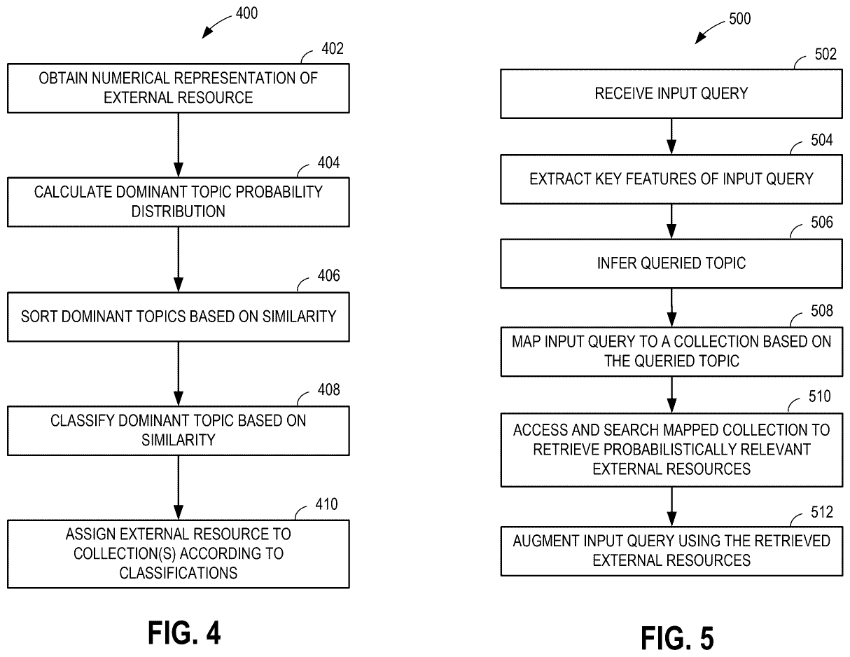

FIG. 4 is a flowchart illustrating an example process 400 for defining a plurality of collections, in accordance with an example of the present disclosure. In examples, one or more operations of process 400 may be executed on each external resource to define a plurality of collections by categorizing one or more external resources to each of a plurality dominant topics. Process 400 may be an example implementation of operation 206 above.

At operation 402, a numerical representation of an external resource can be obtained. In some examples, operation 402 may convert an external resource into a numerical representation, such as vectorized embedding, as described above. Similar to operation 202, operation 402 may include processing the external resource to obtain a string of stemmed key features. In another example, operation 402 may obtain a processed external resource from operation 202. In either case, the key features can be converted to numbers according to language modeling and/or feature learning techniques. The various numbers, representing key features, may be linked together as a numerical representation of the external resource.

At operation 404, a probability distribution of the dominant topics can be calculated for the external resource. That is, a distribution of probabilities that the external resource corresponds to each dominant topic can be calculated. In examples, the probability distribution can be calculated by comparing the numerical representation of the external resource (e.g., from operation 402) with the sets of key features defining the plurality of dominant topics. The comparison can include computing a similarity score between the numerical representations of the external resource and each dominant topic.

At operation 406, the dominant topics can be sorted according to similarity computed at operation 404. For example, the dominant topics can be sorted from highest similarity (e.g. highest probability) to lowest similarity (e.g., lowest probability). At operation 408, the external resource can be classified into the top n dominant topic (e.g., top n dominate topics having the highest probability/similarity). In examples, the number of dominate topics into which an external resource may be classified may correspond to the number of n top/most relevant key features representing the topic. At operation 410, the external resource can be assigned to collections corresponding to the selected dominant topic and can be grouped with (e.g., allocated to) or otherwise stored as part of the collection corresponding to the selected dominant topic.

FIG. 5 is a flowchart illustrating an example process 500 for performing retrieval and augmentation of a query, in accordance with examples of the present disclosure. In examples, process 200 may be implemented as machine-readable instructions that may cause a processor to perform the operations described herein. In some examples, RAG system 102 may be implemented to execute one or more operations disclosed herein.

At operation 502, an input query may be received, for example, from an end-user device (e.g., end-user device 130). In examples, the input query may include a question or other prompt constructed to illicit a responsive output from a generative AI model (e.g., generative AI model 140). The input query may be provided as a character string, an image, a video, audio, multimedia content, or any desired format.

At operation 504, key features are extracted from the input query. For example, the input query may be processed, as described above in connection with FIG. 1 and/or FIG. 2, to extract key features (e.g., key words and phrases in the case of a textual query).

At operation 506, a queried topic is inferred based on the key features obtained at operation 504. For example, operation 506 may discover a queried topic, for example, in a manner similar to discovering dominant topics described above, except that the inference is confined to a single set of key features from the input query. In examples, a numerical representation of the query (referred to herein as a query numerical representation) can be generated. For example, key features of the query can be converted into a vectorized embedding. The vectorized embedding (e.g., query numerical representation) may be used as the queried topic of the query.

The input query can be mapped to one of the plurality of collections based on the queried topic at operation 508. For example, the input query can be mapped to a data structure of a dominant topic by comparing the queried topic to the dominant topics. In this case, a probability distribution of correspondence between the queried topic and the plurality of dominant topics can be computed, for example, based on similarity between the queried topic and each dominant topic. The similarity can be computed from the key features of the input query (operation 404) and sets of key features defining the dominant topics. The dominant topic having the highest similarity can be identified (e.g., by sorting and selecting the first dominant topic in the sored list) and the input query can be mapped to the data structure corresponding to the identified dominant topic.

In some examples, operation 508 may compute a similarity of the query numerical representation to each topical numerical representation of data structures (e.g., generated at operation 410). For example, a topical numerical representation having the highest similarity can be identified. The query can be associated to the data structure corresponding to the identified topical numerical representation. Similarity may be computed using known similarity algorithms, for example but not limited to, cosine similarity, Euclidean distance, Manhattan distance, Jaccard similarity, dot product, soft cosine, angular distance, and the like

At operation 510, the mapped collection can be accessed and searched to retrieve probabilistically relevant external resources from the mapped collection. For example, the mapped data structure may be access to retrieve a collection name contained in the data structure. The collection name can be used as a pointer for locating and accessing the collection in a vector database (e.g., data store 154). Operation 510 may execute an information retrieval algorithm that searches of the external references in the accessed collection. For example, the input query can be compared to the external references to identify those references that probabilistically relevant (e.g., most similar) to the input query. The most relevant external resources may be determined by a threshold similarity and/or a top k number of external resources. In either case, the most relevant external resources can be retrieved via operation 510.

In an example, operation 510 may search the external resources using numerical representations stored in the vector database. For example, the input query can be converted into a numerical representation, which can be used to identify numerical representations of external resources that are probabilistically similar.

At operation 512, an augmented query can be generated, which can be submitted to the generative AI model. For example, operation 512 may augment the input query by adding the external resource retrieved at operation 510 to the input query as a context, which defines the augmented query. The augmented query can be feed to the generative AI model via prompt engineering. As explained above, the generative AI model applies its learned knowledge to the augmented query and generates an output that is responsive to the query and according to the context defined by dominant topic mapped to the input query.

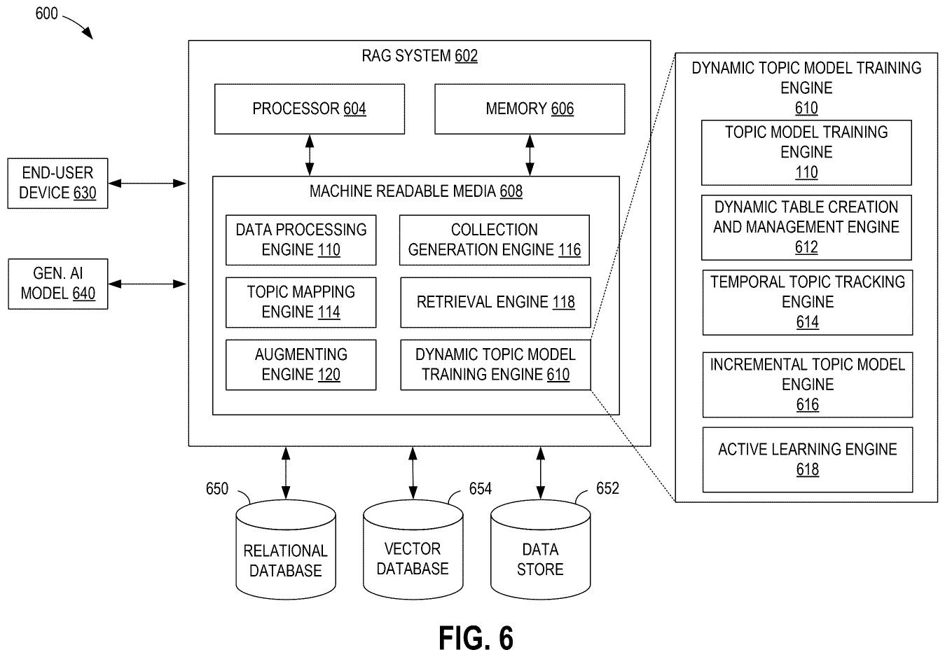

FIG. 6 is a block diagram of an example environment 600, in accordance with an example implementation of the present disclosure. In the example of FIG. 6, environment 600 comprises an RAG system 602, which may be substantively similar to RAG system 102 except as provided herein. As such, RAG system 602 is communicable coupled to end-user device 630, a generative AI model 640 and a plurality of data stores 650-654, each of which are substantively similar to end-user device 130, generative AI model 140 and data stores 150-154, respectively.

In the example of FIG. 6, the RAG system 602 comprises processor 604, memory 606, and machine readable media 608. Processor 604 and memory 606 may be substantively similar to processor 104 and memory 106 of FIG. 1, respectively. Similarly, machine readable media 608 may be substantively similar to machine readable media 108, except as provided here. For example, machine readable media 608 may comprise, for example, data processing engine 110, topic mapping engine 116, collection generation engine 114, retrieval engine 118, and augmentation engine 120, as described above in connection with FIG. 1. Machine readable media 608 may also include dynamic topic model training engine 610, which may comprise topic model training engine 110 of FIG. 1, a dynamic table creation and management engine 612, temporal topic tracking engine 614, incremental topic model engine 616, and active learning engine 618.

The dynamic table creation and management engine 612 may be configured to implement an automated system that continuously monitors the topic distribution across the corpus of extremal documents. In examples, dynamic table creation and management engine 612 may detect a shift in topic distribution, for example, where the covariance increases and/or decreases below a variance threshold (as described above). Upon detecting the shift, dynamic table creation and management engine 612 may be configured to generate an emerging dominant topic and create a new data structure for the emerging dominant topic. In some example, dynamic table creation and management engine 612 may merge dominant topics, for example, by merging data structures for converging dominant topics. The converging topics may be two or more previous dominant topics or one or more previous dominant topics and one or more emerging dominant topics. In some examples, dynamic table creation and management engine 612 may split a data structure into two or more data structures, for example, when a dominant topic becomes too broad (e.g., covariance within the dominant topic exceeds the variance threshold). In each case, collections corresponding to emerging, merged, and/or split dominant topics can be likewise created, merged and/or split and mapped to the resulting dominant topic via the data structure.

The temporal topic tracking engine 614 may be configured to incorporate a time-stamping mechanism for each external resource and dominant topics. For example, a resource time-stamp may be associated with a given external resource indicative of a point in time at which the external resource was stored to the data store 654. As another example, a topic time-stamp may be associated with a given dominant topic indicative of a point in time at which the dominant topic was discovered (e.g., generated). The time-stamps may be inserted into the data structure of a corresponding dominant topic.

The temporal topic tracking engine 614 may also be configured to maintain a temporal graph of dominant topic evolution. For example, the temporal topic tracking engine 614 may monitor the topic time-stamps and corresponding dominant topics to track how dominant topics emerge, merge, split, or fade over time. In some examples, temporal topic tracking engine 614 may implement a sliding window approach for topic modeling, allowing for the detection of trending and declining topics.

In some examples, temporal topic tracking engine 614 may be configured to create temporally-aware data structures that can store external resources from different time periods. For example, temporal topic tracking engine 614 may be configured to create further divisions within a data structure of a given dominant topic, where each division corresponds to a different time period. Time periods may be on any desired basis, for example, by year, by month, by day or any division as desired. Thus, when a query is received by the RAG system 602, the most relevant dominant topic and time period may be located for retrieving only those relevant external resources from the relevant topic and time period. Accordingly, in this example, temporal topic tracking engine 614 may enable time-based retrieval and augmentation.

The active learning engine 618 may be configured for user informed topic refinement. For example, active learning engine 618 may be configured to generate an interactive component on a graphical user interface (GUI) that can be used to engage with end-user for refining the topic model. In examples, active learning engine 618 may present end-users with sets of external resources, via the GUI, and the end-users to validate topic assignment and/or adjust the assignment be designating a different dominant topic. The active learning engine 618 may utilize end-user feedback to refine dominant topic definitions (e.g., by asking the end-user to validate and/or adjust sets of features of dominant topic); adjust dominant topic assignments; and/or identify mislabeled or misclassified external resources. The active learning engine 618 may be configured to employ uncertainty sampling to select the most informative external resources (e.g., most probabilistically similar external resource to the assigned dominant topic) for end-user review, thereby maximizing an impact of end-user input (e.g., if the most probabilistically similar external resource is misclassified, then presumably the rest are misclassified as well).

The incremental topic model engine 616 may be configured to develop an incremental topic model algorithm that can update the topic model as new external resources are added, without requiring a full reprocessing of the entire corpus. In an example, incremental topic model engine 616 may be configured to implement a two-stage approach. First, a rapid initial assignment of one or more new external resources to existing dominant topics can be performed. Second, incremental topic model engine 616 may perform periodic batch updates to refine the topic model. In examples, incremental topic model engine 616 may maintain a buffer of recent external resources to balance between immediate updates and computational efficiency. In some examples, incremental topic model engine 616 may be configured to implement a change detection mechanism to trigger more comprehensive model updates when significant shifts in content are observed by the incremental topic model engine 616.

Accordingly, RAG system 602 can provide a dynamic, adaptive, and comprehensive approach to resource management in RAG. By incorporating multi-modal analysis, temporal awareness, and continuous refinement through active learning and incremental updates, RAG system 602 can offers a solution that is more robust and flexible than conventional RAG approaches. The RAG system 602 can handle evolving knowledge bases, adapt to changing topics over time, and provide more nuanced and relevant responses to user queries.

The following is an illustrative example scenario in which the data store 652 stores a Research Paper Repository. In this example, RAG system 602 may manage a repository of research papers from various fields (e.g., AI, biology, physics, etc.) published over time. The RAG system 602 may need to handle evolving topics, multiple types of content (e.g., text, charts, images), and ensure efficient topic discovery and retrieval as new research papers are ingested.

In this example, dynamic table creation and management engine 612 may perform initial topic monitoring. For example, dynamic table creation and management engine 612 monitors the topics of research papers, using a topic model (e.g., LDA) to categorize papers based on their content. As an example, dynamic table creation and management engine 612 may detect that many new papers are focusing on a newly emerging AI subfield, “Prompt Engineering,” which has not been heavily covered in the corpus of papers before. The dynamic table creation and management engine 612 may perform threshold-based data structure actions. For example, when the number of research papers about “Prompt Engineering” exceeds a certain threshold (e.g., 50 papers), the system may create a new collection to store these documents. Dynamic table creation and management engine 702 may also automatically create a new data structure called, for example, prompt_engineering. Similarly, if two topics (e.g., “Neural Networks” and “Deep Learning”) are found to overlap significantly, their data structures may be merged. Furthermore, if a broad topic (e.g., “Machine Learning”) becomes too general, it can be split into narrower subfields (e.g., “Supervised Learning” and “Unsupervised Learning”).

The temporal topic tracking engine 614 may be configured to time-stamp papers. For example, each research paper may be time-stamped based on its publication date (e.g., 2024 Sep. 1 for a new AI paper) or the date at which it was uploaded to the data store 652. Temporal topic tracking engine 614 may be configured to maintain a temporal graph of topic evolution based on the time stamps. For example, a temporal graph can be maintained to track how topics change over time. For example, “Deep Learning” may be dominant in 2019, while “Prompt Engineering” emerged in 2023.

A sliding window for topic modeling may be utilized by temporal topic tracking engine 614, for example, to analyze how topics trend over time. For instance, temporal topic tracking engine 614 may detect a rising trend in “Quantum Computing” from 2020-2024, while topics like “Support Vector Machines” may decline.

Temporal topic tracking engine 614 may also be configured to configure the data structure as temporally-aware data structures. For example, temporal topic tracking engine 614 may create temporally-aware divisions within the data structures, allowing queries such as, “What were the emerging topics in AI in 2023?” by pulling from time-stamped tables of papers from that year.

In examples, RAG system 602 (and RAG system 102) may be configured for multi-modal topic modeling. For example, multi-modal content can be ingestion. As an illustrative example, when a new research paper is added, the data processing engine 110 may extract, not only the text, but also any relevant charts, images, and tables. NLP can be used to extract and process the paper's written content. CNN-based algorithms can be used to analyze images and detect features, like diagrams or charts. For example, a research paper may include a complex chart of experimental results. Data processing engine 110 may be configured to parse and store these visual elements alongside the text-based content.

Data processing engine 110 may be configured to combine the key features from multi-modal content (e.g., text and visual elements) into a unified topic representation. For example, a paper discussing a “Neural Network Architecture” with both text and diagrams can be categorized as part of a broader “Neural Networks” topic.

The active learning 618 may be implemented for topic refinement. For example, active learning 618 may be configured to utilize end-user feedback for topic refinement. That is, for example, active learning 618 may periodically engage with end-users (e.g., domain experts) to validate or adjust topic assignments. As an illustrative example, active learning 618 may present a set of documents related to “Quantum Computing” and ask the end-user to verify if they are accurately assigned to this topic. Based on the end-user feedback, active learning 618 may be configured to refine the topic model, improving document-topic assignments and detecting misclassifications. For example, a misclassified paper on “Quantum Cryptography” might be reassigned from “General Cryptography” to “Quantum Computing” based on user input. In some examples, active learning 618 may prioritize uncertain documents (e.g., those with ambiguous topic assignments) for user feedback to maximize the impact of human input

In examples, the incremental topic model engine 616 may be configured to provide an initial topic assignment. For example, when a new document (e.g., a research paper on “Quantum Computing”) is added, the incremental topic model engine 616 may assign the paper to an existing topic without retraining the entire topic model. The incremental topic model engine 616 may rapidly assign the new paper to the most relevant topic (e.g., “Quantum Computing”). The topics may be periodically refined by integrating recent papers and re-adjusting topic distributions across the entire document corpus. If incremental topic model engine 616 detects a significant shift is detected in the content (e.g., a large influx of papers on a new AI technique), incremental topic model engine 616 triggers a comprehensive model update to accommodate the new content.

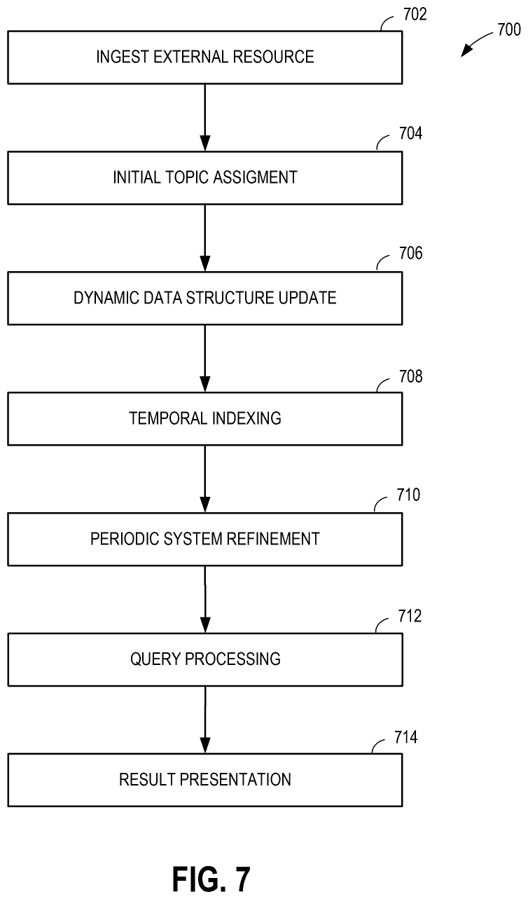

FIG. 7 is a flowchart illustrating an example process 700 of a dynamic retrieval and augmentation, in accordance with an example of the present disclosure. In examples, process 700 may be implemented as machine-readable instructions that may cause a processor to perform the operations described herein. In some examples, RAG system 602 may be implemented to execute one or more operations disclosed herein.

At operation 702, an external resource may be ingested. For example, a new external resource may be added to data store 652. Upon receiving the new external resource, key features can be extracted, for example, as described above in connection with the data processing engine 110.

At operation 704, the external resource may be assigned to an initial dominant topic. For example, the external resource may be assigned to one or more of the existing dominant topics. The existing dominant topics may be discovered, for example, by the topic model training engine 110 and the incremental topic model engine may assign the external resource to one or more of the existing dominant topics. If the external resource doesn't fit well into existing topics, the external resource can be flagged as for potential new topic creation, for example, as an emerging topic. In examples, an external resource may not fit well if the similarity between the external resource and the dominant topic is below a set threshold. Thus, while the initial dominant topic may be the most probable of the existing dominant topics, the external resource may be more indicative of an emerging topic.

In an example of operation 704, a resource numerical representation of the new external resource may be created, for example, as described above in connection with the collection generation engine 116. For example, the external resource may be processed, for example, to obtain a string of stemmed key features. Each key feature may be converted to a number according to language modeling and/or feature learning techniques to provide a numerical representation (e.g., a vectorized embedding). A similarity between the resource numerical representation of the new external resource and each of the topical numerical representations can be computed, as described above. The dominant topic having the highest similarity can be identified and the external resource can be mapped to the collection corresponding to the dominate topic represented by the topical numerical representation. For example, the data structure of the topical numerical representation can be accessed to retrieve a collection name and the external resource can be grouped with the referenced collection. In examples, the topical numerical representation can then be updated to include the new external resource (e.g., by executing operation 206 on the updated collection).

In some examples, the mapping of the new external resource may be based on a similarity threshold. For example, the computed similarity may be compared to a similarity threshold and, if the computed similarity is above the similarity threshold, the new external resource may be mapped to the dominate topic.

If there are no similar dominate topics, a new dominate topic may be created, for example, using a process similar to process 200 of FIG. 2. For example, the new external resource may be added to the corpus and the topic model can be trained on the updated corpus to discover an updated set of dominate topics. The new external document can be classified into dominate documents and a new (or updated) collection can be created that includes the new external resource. A resource numerical representation for the new external resource can be created and stored to a vector database (e.g., data store 654). Topical numerical representations can be created for the updated dominate topics, which can be stored to the vector database and updated data structures can be created. In examples, a new data structure can be created that includes a new collection name and a new dominate topic as a result of the new external resource, which can include the topical numerical representation. The data structure can be stored to a relational data store, such as data store 650/

At operation 706, the data structure can be dynamically updated. For example, based on the topic assignment, operation 706 may add the external resource to an existing collection corresponding to the initial dominant topic assignment; create a new data structure and collection in the case an emerging dominant topic is detected and create a collection by including at least the external resource; or trigger merging or splitting of a collection and correspond data structure if necessary.

At operation 708, temporal indexing may be performed. For example, a resource time-stamp can be created and added to the external resource and the external resource added to a temporal topic graph. The temporal topic graph may provide a relative comparison of numbers of external resource, over time, within each dominant topic. Thus, adding external resource to one such dominant topic can update a topic trajectory for tracking how dominant topics change over time.

At operation 710, periodic system refinement can be performed. For example, at regular intervals (as set by an end-user as desired) and/or triggered by significant changes within the dominant topics, operation 710 may run gather end-user feedback on topic assignments (e.g., using the active learning engine 618). Operation 710 may also update the increment topic model with recent documents and end-user input at the regular intervals and/or as triggered. Furthermore, in some examples, operation 710 may also refine data-structures based on an update in dominant topics and update the temporal topic graph at the regular intervals and/or as triggered.

At operation 712, an input query can be processed. For example, an input query can be received from an end-user device, processed, and augmented as described in connection with process 500. Additionally, due to time-stamps and temporal divisions of the data structures, the input query can be searched for temporal aspects, as well as dominant topic relevancy.

At operation 714, output results of the generative AI model 640 may be presented to the user via the GUI. For example, results may be presented to the end-users with explanations of why each document was selected (e.g., similarity scores with dominant topics) and provide options to explore related topics and temporal trends.

The following is an illustrative example of process 700 applied the Research Paper Repository described above in connection with FIG. 6. In this example, when a new research paper is uploaded (e.g., a 2024 paper on “Quantum AI”), the text, images, and charts, can be extracted and each modality processed separately (operation 702). The features can be combined into a unified topic space. The paper can be assigned to one or more existing topics (e.g., “Quantum Computing” and “AI”) (operation 704). If the document introduces a new topic, it is flagged for potential new topic creation. Relevant data structures can be updated based on the topic assignment (operation 706). If a new topic like “Quantum AI” is detected, a new data structure can be created. The paper can be added to the temporal graph, tracking the rise of topics like “Quantum AI” in 2024 (operation 708). At regular intervals, end-user(s) may be engaged for feedback and the topic model can be updated with recent documents (operation 710). Topic models and data structures can be refined. When an end-user submits a query, such as “Recent papers on Quantum AI,” relevant documents can be retrieved based on topic and time, considering both textual and visual content (operation 712). Results can be presented to the end-user (operation 714), explaining why each document was selected (e.g., based on topic relevance and time) and offering links to related topics or visual representations of topic trends.

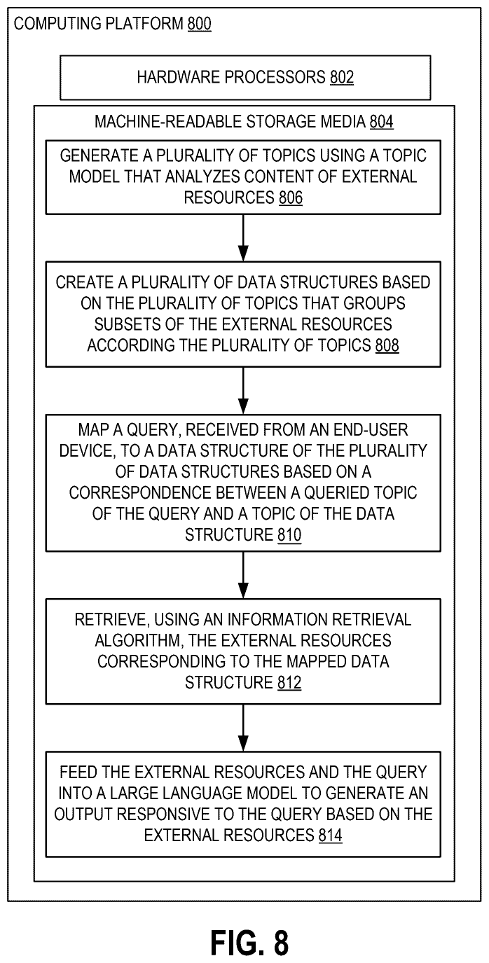

FIG. 8 illustrates a computing component that may be used to implement retrieval augmented generation in accordance with various examples of the disclosed technology. Referring now to FIG. 8, computing component 800 may be, for example, a server computer, a controller, or any other similar computing component capable of processing data. In the example implementation of FIG. 8, the computing component 800 includes a hardware processor 802 and machine-readable storage medium for 804.

Hardware processor 802 may be one or more central processing units (CPUs), semiconductor-based microprocessors, and/or other hardware devices suitable for retrieval and execution of instructions stored in machine-readable storage medium 804. Hardware processor 802 may fetch, decode, and execute instructions, such as instructions 806-814, to control processes or operations disclosed herein. As an alternative or in addition to retrieving and executing instructions, hardware processor 802 may include one or more electronic circuits that include electronic components for performing the functionality of one or more instructions, such as a field programmable gate array (FPGA), application specific integrated circuit (ASIC), or other electronic circuits

A machine-readable storage medium, such as machine-readable storage medium 804, may be any electronic, magnetic, optical, or other physical storage device that contains or stores executable instructions. Thus, machine-readable storage medium 804 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 804 may be a non-transitory storage medium, where the term “non-transitory” does not encompass transitory propagating signals. As described in detail below, machine-readable storage medium 804 may be encoded with executable instructions, for example, instructions 806-814.

The computing component 800 may be an example of or included as part of RAG system 102 and/or RAG system 602 of FIGS. 1 and 6, respectively. Additionally, computing component 800 may be configured to execute one or more of the operations described in connection with FIGS. 2-5 and 7, along with the executing instructions 806-814 described below.

Hardware processor 802 may execute instruction 806 to generate a plurality of topics using a topic model that analyzes content of external resources. For example, instruction 806 may be executed by RAG system 102 and/or 602 to generate a plurality of dominant topics as described above in connection with FIGS. 1-7. In examples, the topic model comprises latent Dirichlet allocation (LDA), but other topic models may be used as desired. The external resources may comprise multiple modalities, such as one or more of textual documents, webpages, images, video, charts, audio, and the like. Generating the plurality of topics may include, for example, processing the external resources using NLP as described above in connection with FIGS. 1 and 2.

Hardware processor 802 may execute instruction 808 to create a plurality of data structures based on the plurality of topics that groups subsets of the external resources according the plurality of topics. In some examples, instruction 808 may be executed to create a plurality of collections of the subsets of the external resources, and map ones of the plurality of collections to ones of the plurality of topics by including references to the plurality of collections in the plurality of data structures, for example, as described above in connection with FIGS. 1-4. The data structures, as described above in connection with FIGS. 1-7, may be SQL tables stored to a relational database (e.g., data store 150 and/or 650).

Hardware processor 802 may execute instruction 810 to map a query, received from an end-user device, to a data structure of the plurality of data structures based on a correspondence between a queried topic of the query and a topic of the data structure. For example, instruction 810 may be executed to analyzing, utilizing natural language processing, the query to identify one or more key features, extract the identified key features, and generate the queried topic (e.g., a queried topic) of the query from extracted key features. In some example, as described above in connection with FIG. 1 and FIG. 5, similarity scores can be computed between the queried topic and the plurality of topics, and the topic resulting in the highest similarity can be mapped to the queried topic.

Hardware processor 802 may execute instruction 812 to retrieve, using an information retrieval algorithm, the external resources corresponding to the mapped data structure. For example, the information retrieval algorithm comprises retrieval augmented generation that locates a collection of the plurality of collections mapped to the topic based on a reference in the mapped data structure and retrieves probabilistically relevant external resources from the located collection. Additional examples and details are provided, for example, in connection with FIGS. 1 and 6-7.

Hardware processor 802 may execute instruction 814 to feed the external resources and the query into a LLM to generate an output responsive to the query based on the external resources. As described above, an augmented query can be generated by adding the retrieved external resources to the query as context and the LLM may apply its learned knowledge to the augmented query to generate an output that is responsive to the query confined to the mapped topic.

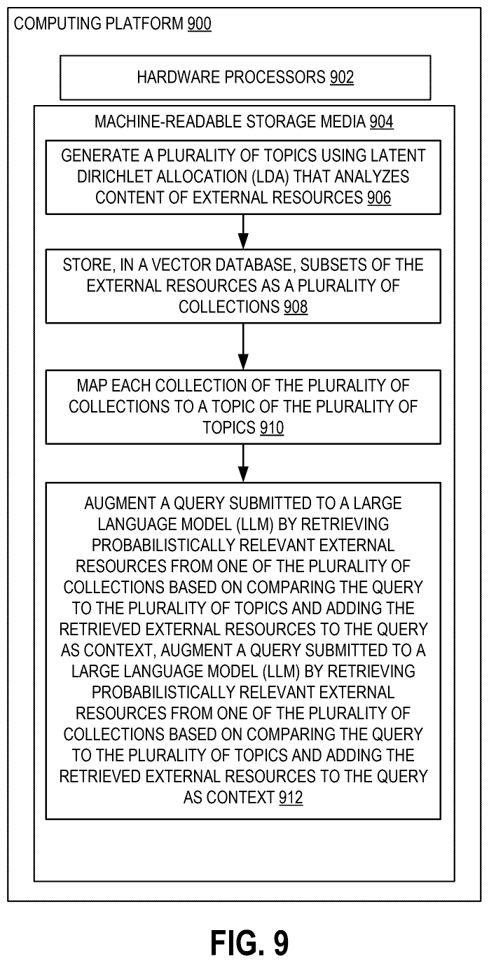

FIG. 9 illustrates another computing component that may be used to implement retrieval augmented generation in accordance with various examples of the disclosed technology. Referring now to FIG. 9, computing component 900 may be, for example, a server computer, a controller, or any other similar computing component capable of processing data. In the example implementation of FIG. 9, the computing component 900 includes a hardware processor 902 and machine-readable storage medium for 904.

Hardware processor 902 may be one or more central processing units (CPUs), semiconductor-based microprocessors, and/or other hardware devices suitable for retrieval and execution of instructions stored in machine-readable storage medium 904. Hardware processor 902 may fetch, decode, and execute instructions, such as instructions 906-912, to control processes or operations disclosed herein. As an alternative or in addition to retrieving and executing instructions, hardware processor 902 may include one or more electronic circuits that include electronic components for performing the functionality of one or more instructions, such as a field programmable gate array (FPGA), application specific integrated circuit (ASIC), or other electronic circuits

A machine-readable storage medium, such as machine-readable storage medium 904, may be any electronic, magnetic, optical, or other physical storage device that contains or stores executable instructions. Thus, machine-readable storage medium 904 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 904 may be a non-transitory storage medium, where the term “non-transitory” does not encompass transitory propagating signals. As described in detail below, machine-readable storage medium 904 may be encoded with executable instructions, for example, instructions 906-912.

The computing component 900 may be an example of or included as part of RAG system 102 and/or RAG system 602 of FIGS. 1 and 6, respectively. Additionally, computing component 900 may be configured to execute one or more of the operations described in connection with FIGS. 2-5 and 7, along with the executing instructions 906-912 described below.

Hardware processor 902 may execute instruction 906 to generate a plurality of topics using LDA that analyzes content of external resources. For example, as described above in connection with FIGS. 1-3, external resource can be processed and analyzed to discover a plurality of dominant topics.

Hardware processor 902 may execute instruction 908 to store, in a vector database, subsets of the external resources as a plurality of collections. For example, as described above in connection with FIGS. 1-4, external resource can be converted into numerical representations (e.g., vector embeddings), which can be grouped or categorized into collections according to similarity to the generated topics.

Hardware processor 902 may execute instruction 910 to map each collection of the plurality of collections to a topic of the plurality of topics. For example, as described above in connection with FIGS. 1-4, instruction 910 may be executed to create a plurality of tables for the plurality of topics and assign the subsets of the external resources to the plurality of topics based on comparing the content of the external resources to the plurality of topics. The plurality of tables can be populated with references to the plurality of collections based on the subsets of external resources assigned to the plurality of topics and each collection mapped to the plurality of topics.

Hardware processor 902 may execute instruction 912 to augment a query submitted to a large language model (LLM) by retrieving probabilistically relevant external resources from one of the plurality of collections based on comparing the query to the plurality of topics and adding the retrieved external resources to the query as context. The LLM may output a response that is responsive to the query based on the external resources and confined to a topic of the plurality of topics. In an example, as described above in connection with FIGS. 1 and 5, instruction 910 may include extracting, utilizing NLP, the query to identify one or more key features and inferring a queried topic from the extracted key features. In this case, for example, comparing the query to the plurality of topics can include computing similarity scores between the queried topic and the plurality of topics. The probabilistically relevant external resources can be retrieved from a collection mapped to a topic of the plurality of topics resulting in the highest similarity score.

FIG. 10 depicts a block diagram of an example computer system 1000 in which various examples of the disclosed technology described herein may be implemented. The computer system 1000 includes a bus 1002 or other communication mechanism for communicating information, one or more hardware processors 1004 coupled with bus 1002 for processing information. Hardware processor(s) 1004 may be, for example, one or more general purpose microprocessors. The computer system 10000 may be implemented as one or more component of the environment 100 of FIG. 1 and/or environment 600 of FIG. 6.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions. For example, main memory 1006 may store instructions, that when executed by processor(s) 1004, cause computer system 1000 to perform one or more of the operations described in connection with FIGS. 2-5 and 7-9.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions.

The computer system 1000 may be coupled via bus 1002 to a display 1012, such as a liquid crystal display (LCD) (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. In some examples, the same direction information and command selections as cursor control may be implemented via receiving touches on a touch screen without a cursor.

The computing system 1000 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAs, firmware and/or program logic which in combination with the computer system causes or programs computer system 1000 to be a special-purpose machine. According to one example of the disclosed technology, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1002. Transmission media can also take the form of acoustic or light waves, such as those generated during radio-wave and infra-red data communications.

The computer system 1000 also includes a network interface 1018 (also referred to as a communication interface) coupled to bus 1002. Network interface 1018 provides a two-way data communication coupling to one or more network links that are connected to one or more local networks. For example, communication interface 1018 may be an integrated services digital network (ISDN) card, cable modem, satellite modem, or a modem to provide a data communication connection to a corresponding type of telephone line. As another example, network interface 1018 may be a local area network (LAN) card to provide a data communication connection to a compatible LAN (or WAN component to communicated with a WAN). Wireless links may also be implemented. In any such implementation, network interface 1018 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 1018, which carry the digital data to and from computer system 1000, are example forms of transmission media.

The computer system 1000 can send messages and receive data, including program code, through the network(s), network link and network interface 1018. In the Internet example, a server might transmit a requested code for an application program through the Internet, the ISP, the local network and the network interface 1018.

The received code may be executed by processor 1004 as it is received, and/or stored in storage device 1010, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1000.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

1. A method for retrieval augmented generation, the method comprising:
generating a plurality of topics using a topic model that analyzes content of external resources;
creating a plurality of data structures based on the plurality of topics that groups subsets of the external resources according the plurality of topics;
mapping a query, received from an end-user device, to one or more structures of the plurality of data structures based on a correspondence between a queried topic of the query and topics one or more data structures;
retrieving, using an information retrieval algorithm, one or more external resources corresponding to the mapped one or more data structures by accessing and searching the subsets of the external resources confined to the mapped one or more data structures; and
feeding the one or more external resources and the query into a generative artificial intelligence model that generates an output responsive to the query based on the one or more external resources.

2. The method of claim 1, wherein the topic model comprises latent Dirichlet allocation (LDA).

3. The method of claim 1, wherein the information retrieval algorithm comprises retrieval augmented generation.

4. The method of claim 1, wherein the external resources comprises one or more of textual documents, webpages, images, video, charts, or audio.

5. The method of claim 1, wherein retrieving the external resources corresponding to the mapped one or more data structures comprises:
retrieving the one or more external resources corresponding to only the mapped one or more data structures.

6. The method of claim 1, further comprises:
analyzing, utilizing natural language processing, the query to identify one or more of: keywords or phrases;
extracting the identified one or more of: keywords or phrases; and
generating the queried topic of the query from extracted one or more of: keywords or phrases.

7. The method of claim 1, further comprising:
creating a plurality of collections of the subsets of the external resources; and
mapping ones of the plurality of collections to ones of the plurality of topics by including references to the plurality of collections in the plurality of data structures.

8. The method of claim 7, wherein retrieving the external resources corresponding to the mapped one or more data structures comprises:
locating a collection of the plurality of collections mapped to a respective topic based on a reference in the mapped data structure; and
retrieving probabilistically relevant external resources of the located collection.

9. The method of claim 1, further comprising:
adding time-stamps of the external resources; and
tracking the plurality of topics according to the time-stamps.

10. A system, comprising:
a memory storing instructions; and
a processor communicably coupled to the memory and configured to execute the instructions to:
generate a plurality of topics using a topic model that analyzes content of external resources;
create a plurality of data structures based on the plurality of topics that groups subsets of the external resources according the plurality of topics;
map a query, received from an end-user device, to one or more data structures of the plurality of data structures based on a correspondence between a queried topic of the query and topics of the one or more data structures;
retrieve, using an information retrieval algorithm, one or more external resources corresponding to the mapped one or more data structures by accessing and searching the subsets of the external resources confined to the mapped one or more data structures; and
feed the one or more external resources and the query into a generative artificial intelligence model that generates an output responsive to the query based on the one or more external resources.

11. The system of claim 10, wherein the topic model comprises latent Dirichlet allocation (LDA).

12. The system of claim 10, wherein the information retrieval algorithm comprises retrieval-augmented generation.

13. The system of claim 10, wherein the external resources comprises one or more of textual documents, webpages, images, video, charts, or audio.

14. The system of claim 10, wherein retrieving the external resources corresponding to the mapped one or more data structures comprises:
retrieving the one or more external resources corresponding to only the mapped one or more data structures.

15. The system of claim 10, wherein the processor is further configured to execute the instructions to:
analyze, utilizing natural language processing, the query to identify one or more of: keywords or phrases;
extract the identified one or more of: keywords or phrases; and
generate the queried topic of the query from extracted one or more of: keywords or phrases.

16. The system of claim 10, wherein the processor is further configured to execute the instructions to:
create a plurality of collections of the subsets of the external resources; and
map ones of the plurality of collections to ones of the plurality of topics by including references to the plurality of collections in the plurality of data structures.

17. The system of claim 16, wherein retrieving the external resources corresponding to the mapped one or more data structures comprises:
locating a collection of the plurality of collections mapped to a respective topic based on a reference in the mapped data structure; and
retrieving probabilistically relevant external resources of the located collection.

18. A non-transitory computer-readable storage medium storing instructions that, when executed by a processor, cause the processor to:
generate a plurality of topics using latent Dirichlet allocation (LDA) that analyzes content of external resources;
store, in a vector database, subsets of the external resources as a plurality of collections;
map each collection of the plurality of collections to a topic of the plurality of topics; and
augment a query submitted to a large language model (LLM) by identifying one or more topics of the plurality of topics based on comparing the query to the plurality of topics retrieving probabilistically relevant external resources from one or more collections of the plurality of collections confined to the identified one or more topics, and adding the retrieved external resources to the query as context,
wherein the LLM outputs a response that is responsive to the query based on the external resources.

19. The non-transitory computer-readable storage medium of claim 18, wherein the instructions further cause the processor to:
extract, utilizing natural language processing, the query to identify one or more key features;
infer a queried topic from the extracted key features; and
wherein comparing the query to the plurality of topics comprises computing similarity scores between the queried topic and the plurality of topics,
wherein the identified one or more topics result in the highest similarity scores.

20. The non-transitory computer-readable storage medium of claim 18, wherein mapping each collection of the plurality of collections to a topic of the plurality of topics comprises:
creating a plurality of tables for the plurality of topics;
assigning the subsets of the external resources to the plurality of topics based on comparing the content of the external resources to the plurality of topics; and
populating the plurality of tables with references to the plurality of collections based on the subsets of external resources assigned to the plurality of topics and each collection mapped to the plurality of topics.
